(19) United States
(12) Patent Application Publication
(10) Pub. No.: US 2015/0019893 A1
(43) Pub. Date: Jan. 15, 2015

(54) STANDBY POWER INTERCEPTION APPARATUS FOR COMPUTER AND COMPUTER PERIPHERAL DEVICE

(71) Applicant: Gang-Won Kim, (US)

(72) Inventor: Chang-Ho Kim, Seoul (KR)

(73) Assignee: Gang-Won Kim

(21) Appl. No.: 14/498,646

(22) Filed: Sep. 26, 2014

Related U.S. Application Data
(63) Continuation of application No. PCT/KR2013/002476, filed on Mar. 26, 2013.

(30) Foreign Application Priority Data
Mar. 26, 2012 (KR) 10-2012-0030352

(51) Int. Cl. G06F 1/32

(52) U.S. Cl. CPC G06F 1/3284
USPC 713/323

(57) ABSTRACT

The present invention relates to a computer and a method for controlling same, in which power being supplied to a computer peripheral device is completely intercepted in a standby mode (power saving mode) or a monitor power-off mode during use of the computer, and power being supplied to the computer and to the computer peripheral device is completely intercepted when the power of the computer is turned ‘off’. Conventional computers have disadvantages that monitor screens are turned off but power is continuously supplied to monitors and computer peripheral devices that consume power in a standby mode (power saving mode) or a monitor power-off mode during use of the computer, and standby power of the computer is wasted when the power of the computer is turned ‘off’, and standby power of computer peripheral devices (monitor, printer, speaker, etc.) is continuously wasted. Such an unnecessary power waste may cause energy waste and generation of CO2, thus causing environmental contamination. The present invention solves these problems, which involve power being wasted by a computer and standby power zero being wasted, without unplugging, and inhibits excessive emission of CO2 caused by an unnecessary production of power to reduce environmental contamination.

### CROSS-REFERENCE TO RELATED APPLICATIONS

This is a continuation of International Application No. PCT/KR2013/002476 filed on Mar. 26, 2013, which claims priority to Korean Application No. 10-2012-0030352 filed on Mar. 26, 2012, which applications are incorporated herein by reference.

### TECHNICAL FIELD

The present disclosure relates to a device which completely blocks power supplied to computer peripheral devices in a standby mode (power saving mode) or a monitor power-off mode when a computer is being used and power supplied to the computer and to the peripheral devices when the power is turned off.

### BACKGROUND ART

In general, a computer is connected with various peripheral devices. Among the computer peripheral devices, there is a device having a function of autonomously blocking power for power saving when the computer enters a power saving mode. For example, a monitor turns off a screen thereof to reduce power consumption to about 15 W in a power saving mode and deactivates functions thereof to enter a standby state when a computer is turned off, in which case standby power of about 4 W is generally consumed. A printer also always consumes power of about 4 W.

As described above, according to the related art, when the computer enters the monitor power-off mode, the monitor screen is turned off so as to reduce an unnecessary waste of power, thereby decreasing power consumption. However, power is not blocked so completely that the peripheral devices including the monitor, the printer, an external speaker, and the like are supplied with power, thereby wasting power consumption. In addition, even when the computer is turned off, the computer and the peripheral devices consume standby power. In the production of the unnecessarily wasted power, CO2 is generated to thereby cause environmental pollution.

### SUMMARY

Accordingly, the present disclosure has been made in an effort to solve the above-described problems associated with prior art. The present disclosure provides a device which can completely block power supplied to computer peripheral devices in a standby mode (power saving mode) or a monitor power-off mode while a computer is being used and completely block power supplied to the computer and the peripheral devices when the computer is turned off, thereby reducing power consumption.

In accordance with one aspect of the disclosure, there is provided a computer 10 having a standby power cut-off function, which includes a power switch 20 provided at a front end thereof such that power is supplied to the computer therethrough, the power switch 20 completely blocking power when the computer is turned off, thereby blocking standby power of the computer 10 and peripheral devices (a printer 40, a monitor 50, etc.). That is, the computer is provided with a power supply 16 that receives external general-purpose power and supplies operating power to internal function blocks of the computer, and the power switch 20 is provided, for example, on a path along which external general-purpose power of 220 V is supplied to the power supply 16 and completely blocks power supplied to the power supply 16 according to a control signal.

The computer includes a signal sensing & control unit 17 as a means for sensing a computer monitor power-off mode, the signal sensing & control unit 17 sensing a presence or absence of a horizontal synchronization (H-Sync) signal and a vertical synchronization (V-Sync) signal to control such that power supplied to a peripheral device is blocked. When neither of the signals is sensed, the signal sensing & control unit 17 determines that the computer is in the monitor power-off mode and outputs a control signal for blocking/supplying power to the peripheral device. The computer is provided therein with an outlet power switch 19 as a means for blocking/supplying power to the peripheral device and controls the outlet power switch 19 to block power supplied to a peripheral device outlet 18, thereby blocking the power supplied to the peripheral device.

In addition, when the computer enters a standby mode (a power saving mode), the graphic controller 13 does not output a horizontal synchronization (H-Sync) signal, a vertical synchronization (V-Sync) signal, or a +5 V power voltage signal, and power is supplied to a memory. The signal sensing & control unit 17 senses the power supplied to the memory and, even in the standby mode (power saving mode), controls the outlet power switch 19, which is a means for blocking/supplying the power to the peripheral device, to block power supplied to the peripheral device outlet 18, thereby blocking power supplied to the peripheral device and thus reducing the waste of power.

Further, when the computer is turned off, the signal sensing & control unit 17 senses that the graphic controller 13 does not output a horizontal synchronization (H-Sync) signal, a vertical synchronization (V-Sync) signal, a +5 V power voltage signal, or a memory power, and controls the power switch 20 to block power of the computer and the peripheral device, thereby completely decreasing wasted standby power to zero and thus reducing the waste of power.

As described above, the present disclosure provides a standby power cut-off device which can completely block power supplied to computer peripheral devices in a standby mode (power saving mode) or a monitor power-off mode while a computer is being used and completely block power supplied to the computer and the peripheral devices when the computer is turned off, to thereby completely block power wasted by the peripheral devices while the computer is being used and power wasted by the computer and the peripheral devices when the computer is turned off, thus resulting in a reduction in wasted energy and CO2 caused by power production and preventing environmental pollution.

### BRIEF DESCRIPTION OF THE DRAWINGS

FIG. 1 is a block diagram of a standby power cut-off device for a computer and a computer peripheral device according to an embodiment of the present disclosure; and

FIG. 2 illustrates an example of detailed configurations for the signal sensing & control unit 17, the power supply 16, the power switch 20, the outlet power switch 19, and the peripheral device outlet 18 which are important parts illustrated in FIG. 1.

### DETAILED DESCRIPTION

Hereinafter, exemplary embodiments of the present disclosure will be described in detail with reference to the accompanying drawings. In the following description, specific details such as a signal sensing & control unit, an outlet power switch, a power switch, a power supply, a Central Processing Unit (CPU), a graphic controller, a peripheral device outlet, a memory, and the like are provided to help with overall comprehension of the present disclosure. It is apparent to those skilled in the art that modifications and variations can be made to the specific details without departing from the spirit and scope of the present disclosure.

Configurations of the present disclosure and operations thereof will be described in detail with reference to the accompanying drawings.

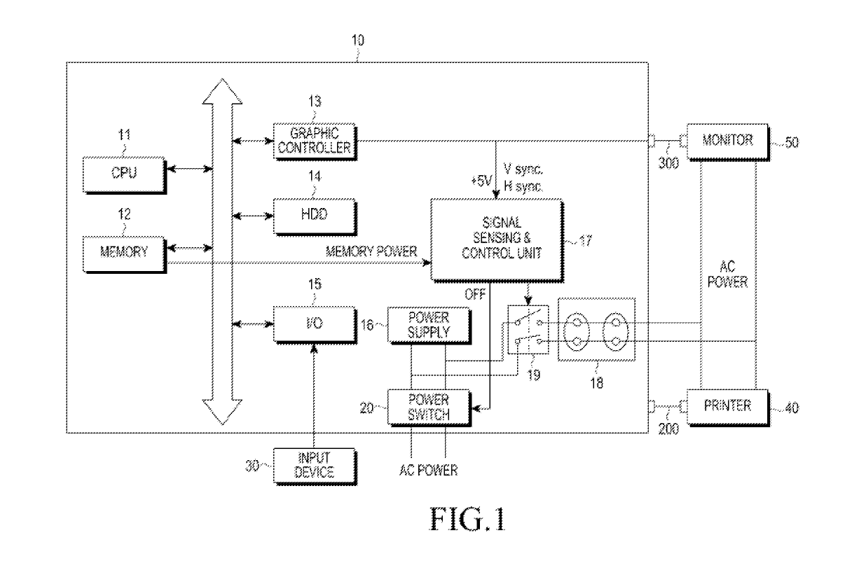

FIG. 1 is a block diagram of a standby power cut-off device for a computer and a computer peripheral device according to an embodiment of the present disclosure. Referring to FIG. 1, a computer 10 includes:

a CPU 11 that performs all operations and controls; a memory 12 that stores an operating program of the CPU 11, various pieces of data required for operations, and various pieces of data to be temporarily stored during operations; a Hard Disk Drive (HDD) 14; a graphic controller 13 that controls graphics by outputting image signals and horizontal/vertical synchronization (H/V Sync) signals to a monitor 50; an I/O controller 15 that controls input/output; an input device 30 such as a keyboard, a mouse, etc.; a power supply 16 that supplies power to the computer; a power switch 20 that turns on/off the power supply and supplies/blocks power, a signal sensing & control unit 17 that senses a state of the computer to control the power switch 20 for supplying/blocking main power and power to a peripheral device; an outlet power switch 19 that supplies/blocks power to the peripheral device under the control of the signal sensing & control unit 17; and a peripheral device outlet 18 to which a power plug of the peripheral device is connected. The monitor 50 and a printer 40 illustrated as a peripheral device in FIG. 1 are connected with the peripheral device outlet 18 to receive operating power. The monitor 50 is connected with the graphic controller 13 of the computer 10 through a monitor cable 300, and the printer 40 is connected with the computer 10 through a printer cable 200.

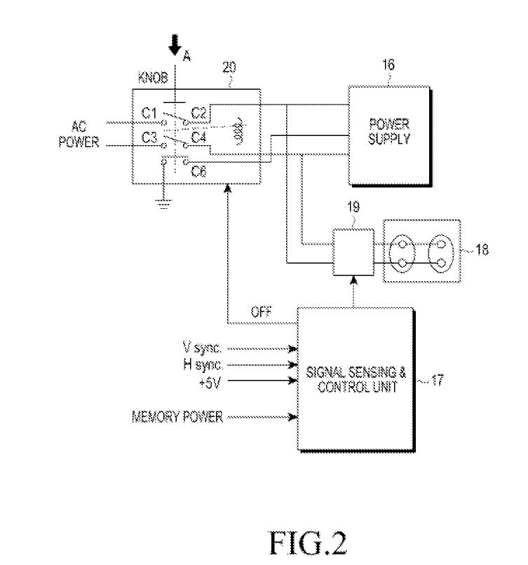

FIG. 2 illustrates an example of detailed configurations for the signal sensing & control unit 17, the power supply 16, the power switch 20, the outlet power switch 19, and the peripheral device outlet 18 which are important parts illustrated in FIG. 1. These elements are main elements of the standby power cut-off device for the computer and the computer peripheral device according to the embodiment of the present disclosure. Operations of the respective elements will be described in more detail. In front of the power supply 16 which receives external general-purpose power and supplies operating power to internal function blocks of the computer, the power switch 20 is provided on a path along which the external general-purpose power is supplied to the power supply 16, and blocks the power supplied to the power supply under external control.

The peripheral device outlet 18 is connected with the power switch 20 in common with the power supply 16 and supplies power to computer peripheral devices connected thereto.

In front of the peripheral device outlet 18, the outlet power switch 19 is provided on a path along which the external general-purpose power is supplied to the peripheral device outlet 18 through the power switch 20, and blocks the power supplied to the peripheral device outlet 18 under external control.

The signal sensing & control unit 17 senses a presence or absence of a horizontal/vertical synchronization signal provided from the computer to the monitor and a power on/off state of at least one (a memory in FIG. 2) of internal configurations set in advance such that power is supplied within the computer even in a power saving mode or a standby mode to thereby control operations of the power switch 20 and the outlet power switch 90.

In a monitor power-off mode, the signal sensing & control unit 17 controls the outlet power switch 19 to block power supplied to the peripheral device outlet 18 when the horizontal or vertical synchronization signal is not sensed. In this case, the computer 10 operates normally as it is.

Furthermore, in a standby mode, the signal sensing & control unit 17 controls the outlet power switch 19 to block power supplied to the peripheral device outlet 18 when the horizontal or vertical synchronization signal is not sensed and power is continuously supplied to the memory.

Moreover, in a power-off mode, the signal sensing & control unit 17 controls the power switch 20 to block power supplied to the power supply 18 when the horizontal or vertical synchronization signal is not sensed and power is not supplied to the memory.

The configurations in the embodiment of the present disclosure and operating principles thereof will be described in more detail with reference to FIG. 2. When a knob of the power switch 20 is pressed in a direction of an arrow denoted by A, contact points C1, C3, and C5 are connected with contact points C2, C4, and C6, respectively, so that the power supply 16 is supplied with power and supplies necessary power to the computer. When the knob is released, the contact points

C5 and C6 are opened after providing only a power-on signal of the power supply 16, and the contact points C1 and C2 and the contact points C3 and C4 are maintained in the connected state, thereby supplying power.

The power switch 20 may be constructed by using the apparatus for cutting off standby power which is disclosed in KR Patent No. 10-0945210 of the present inventor. When power is supplied to the computer, the signal sensing & control unit 17 controls the outlet power switch 19 to supply power to the peripheral device outlet 18. The outlet power switch 19 may be constructed with a semiconductor device such as a relay or a triac.

A control method in a case of entering a monitor power-off mode to reduce power consumption during use of the computer will be described.

In the case in which the computer enters the monitor power-off mode in order to reduce power consumption when there is no task for a predetermined period of time, the signal sensing & control unit 17 senses that the graphic controller 13 does not output a V- or H-Sync signal. Thereafter, the signal sensing & control unit 17 controls the outlet power switch 19 to block power supplied to the peripheral device outlet 18, thereby completely blocking power to the peripheral devices. In this case, since only the computer normally operates, the computer consumes normal power.

If there is an input through a mouse or a keyboard in order to use the computer again, the computer normally operates and the graphic controller 13 normally outputs a V- or H-Sync signal. When sensing the signal, the signal sensing & control unit 17 controls the outlet power switch 19 such that power is supplied to the peripheral devices through the peripheral device outlet 18, thereby enabling the peripheral devices to operate normally.

After the computer is turned off, it takes much time to reboot the computer. As a result, in order to use the computer again, a user has to wait for a long time until the computer is completely booted up. So, for immediate use of the computer and a reduction in power waste, the computer may enter a standby mode (power saving mode) when not used for a predetermined period of time or more. At this time, the computer stores data before the power saving mode in the memory thereof and therefore, can directly return to the previous state when there is an input through the mouse or the keyboard. A control method for blocking power of the peripheral devices in this case will be described below.

Provided the computer enters the standby mode (power saving mode),

Then, the graphic controller 13 does not output a V- or H-Sync signal or a +5 V power voltage signal and power is applied only to the memory 12 for storage of the previous state so that memory power is maintained. When sensing the above-described state, the signal sensing & control unit 17 controls the outlet power switch 19 to block power supplied to the peripheral device outlet 18, thereby completely blocking power to the peripheral devices and reducing power wasted by the peripheral devices.

When there is an input through the mouse or the keyboard in order to use the computer again, the computer returns to the previous state stored in the memory 12 without booting thereof, and the graphic controller 13 normally outputs a V- or H-Sync signal or +5 V power voltage signal. The signal sensing & control unit 17, when sensing the signal, controls the outlet power switch 19 to supply power to the peripheral devices through the peripheral device outlet 18, thereby enabling the peripheral devices to operate normally.

A control method for power off will be described.

When the computer is shut down, the graphic controller 13 does not output a V- or H-Sync signal or +5 V power voltage signal and the memory 12 is not supplied with memory power. The signal sensing & control unit 17, when sensing the state, outputs an OFF control signal to operate a solenoid of the power switch 20, thereby opening the contact points C1 and C2 and the contact points C3 and C4 so that the power supplied to the computer and the peripheral devices is completely blocked and the wasted power is thus completely “0W”.

As described above, according to the embodiment of the present disclosure, the computer may be configured to completely block the standby power of the computer and the peripheral devices. Although the specific embodiments of the computer and the peripheral devices have been illustrated above, various modifications can be made without departing from the scope of the present disclosure.

For example, although the signal sensing & control unit has been illustrated as operating by discerning the power on/off state of the memory, it is also possible to discern a power on/off state of a light emitting diode for indicating a power saving mode or a standby state.

In addition to that, various modifications and variations can be made without departing from the scope of the present disclosure, and the scope of the present disclosure shall not be determined by the above-described embodiments and has to be determined by the following claims and equivalents thereof.

1. A standby power cut-off device for a computer and a computer peripheral device, comprising:
a power switch that is provided on a path along which external general-purpose power is supplied to a power supply and blocks the power supplied to the power supply under external control, the power switch being in front of the power supply which receives the external general-purpose power in a computer and supplies operating power to internal function blocks of the computer;
a peripheral device outlet that is connected with the power switch in common with the power supply and supplies power to a computer peripheral device connected thereto;
an outlet power switch that is provided on a path along which the external general-purpose power is supplied to the peripheral device outlet through the power switch and blocks the power supplied to the peripheral device outlet under external control, the outlet power switch being in front of the peripheral device outlet; and
a signal sensing & control unit that senses a presence or absence of a horizontal or vertical synchronization signal provided from the computer to a monitor and a power on/off state of at least one of internal configurations set in advance such that power is supplied within the computer even in a power saving mode or a standby mode to thereby control operations of the power switch and the outlet power switch.

2. The standby power cut-off device of claim 1, wherein the signal sensing & control unit controls the outlet power switch to block power supplied to the peripheral device outlet when the horizontal or vertical synchronization signal is not sensed.

3. The standby power cut-off device of claim 1, wherein the signal sensing & control unit controls the outlet power switch to block power supplied to the peripheral device outlet when the horizontal or vertical synchronization signal is not sensed and power is continuously supplied to the internal configurations set in advance such that the power is supplied even in the power saving mode or the standby mode.

4. The standby power cut-off device of claim 3, wherein, after controlling the outlet power switch to block the power supplied to the peripheral device outlet, the signal sensing & control unit controls the outlet power switch to supply power to the peripheral device outlet when the horizontal or vertical synchronization signal is sensed and the power is continuously supplied to the internal configurations set in advance such that the power is supplied even in the power saving mode or the standby mode.

5. The standby power cut-off device of claim 1, wherein the signal sensing & control unit controls the power switch to block power supplied to the power supply when the horizontal or vertical synchronization signal is not sensed and power is not supplied to the internal configurations set in advance such that the power is supplied even in the power saving mode or the standby mode.

6. The standby power cut-off device of claim 1, wherein the internal configurations set in advance such that the power is supplied even in the power saving mode or the standby mode comprise a memory.
